(19) United States
(12) Patent Application Publication
(10) Pub. No.: US 2018/0200707 A1
(43) Pub. Date: Jul. 19, 2018

(54) AIR PURIFYING MATERIAL AND METHOD OF PREPARING THE SAME

(71) Applicant: BOE TECHNOLOGY GROUP CO., LTD., Beijing (CN)

(72) Inventor: Lizhong WANG, Beijing (CN)

(21) Appl. No.: 15/709,859

(22) Filed: Sep. 20, 2017

(30) Foreign Application Priority Data
Jan. 19, 2017 (CN) 201710038229.8

(51) Int. Cl. B01J 35/00

(52) U.S. Cl. CPC B01J 35/004; B01J 35/1014; B01D 2255/802

(57) ABSTRACT

The present disclosure provides an air purifying material and a method of preparing the same. In the embodiment of the present disclosure, the solvent is added to the mixture of the zinc acetate and the gallium nitrate to form a sol-gel precursor which is then sintered to form a porous particulate zinc gallate precursor. The porous particulate zinc gallate precursor forms a solid solution of gallium nitride and zinc oxide after undergoing a nitriding process.

### CROSS REFERENCE

The present application is based upon and claims priority to Chinese Patent Application No. 201710038229.8, filed on Jan. 19, 2017, and the entire contents thereof are incorporated herein by reference.

### TECHNICAL FIELD

The present disclosure relates to photocatalytic semiconductor materials, more specifically, to an air purifying material and a method of preparing the same.

### BACKGROUND

With the improvement of people's living standards, people pay more and more attention to the harm of air pollution to human health. Some organic pollutants in the air, such as formaldehyde, benzene, toluene, carbon monoxide, isopropyl alcohol etc., seriously threaten people's health.

The conventional photocatalysts are widely used currently, such as titanium dioxide, which produce photogenerated electron-hole pairs by absorbing solar energy. On the surface of the photocatalysts, the photogenerated electron-hole pairs react with the oxygen and the water vapor in the air to generate different free radical trapping agents, by which the organic pollutants in the air are degraded to water and carbon dioxide.

When applying the existing technology, the inventor of the present disclosure found that, the conventional photocatalysts, such as titanium dioxide, can only make use of the ultraviolet spectrum that makes up less than 5% of the solar energy since they are semiconductor materials which can only respond to ultraviolet rays, and hence the solar energy is mostly wasted. Besides, the conventional photocatalysts are all in the form of particulate solid and thus have a relatively small contact area with the organic pollutants. As a result, the degradation effect on the organic pollutants is poor and the photocatalysts cannot be efficiently used, causing a waste of the photocatalysts.

It should be noted that, information disclosed in the above background portion is provided only for better understanding of the background of the present disclosure, and thus it may contain information that does not form the prior art known by those ordinary skilled in the art.

### SUMMARY

The present disclosure provides a method of preparing an air purifying material and a corresponding air purifying material.

One aspect of the present disclosure provides a method of preparing an air purifying material, including:

mixing zinc acetate and gallium nitrate to obtain a mixture, and adding a solvent to the mixture to form a sol-gel precursor;

sintering the sol-gel precursor to form a porous particulate zinc gallate precursor;

nitriding the porous particulate zinc gallate precursor to form a porous solid solution of gallium nitride and zinc oxide.

Another aspect of the present disclosure provides an air purifying material, the air purifying material includes a solid solution of gallium nitride and zinc oxide and is prepared through the method of preparing an air purifying material described above.

It is to be understood that both the foregoing general description and the following detailed description are exemplary and explanatory only and are not restrictive of the disclosure, as claimed.

This section provides a summary of various implementations or examples of the technology described in the disclosure, and is not a comprehensive disclosure of the full scope or all features of the disclosed technology.

### BRIEF DESCRIPTION OF THE DRAWINGS

Various other advantages and benefits will become apparent to those skilled in the art upon reading the detailed description of the embodiments described below. The drawings are for the purpose of illustration only and are not to be considered as limiting the disclosure. The same reference numerals are used to designate like parts throughout the drawings. In the drawings,

FIG. 1 illustrates a flow chart of the method of preparing an air purifying material according to the first embodiment of the present disclosure;

FIG. 2 illustrates a flow chart of the method of preparing an air purifying material according to the second embodiment of the present disclosure;

FIG. 3 illustrates a flow chart of the method of preparing an air purifying material according to the third embodiment of the present disclosure;

FIG. 4 schematically illustrates the structure of the air purifying material prepared according to the present disclosure.

### DETAILED DESCRIPTION

Exemplary embodiments of the present disclosure will be described in more detail below with reference to the drawings. It should be understood that the present disclosure may be embodied in various forms and should not be limited to the embodiments set forth herein, while the exemplary embodiments of the present disclosure are shown in the drawings. On the contrary, these embodiments are provided to enable a more thorough understanding of the present disclosure and to teach the scope of the disclosure completely to those skilled in the art.

### Embodiment 1

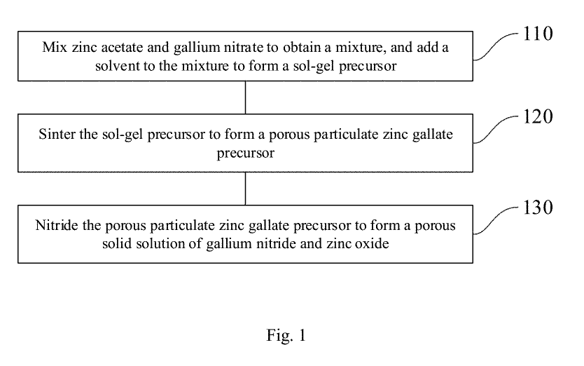

As shown in FIG. 1, it illustrates a flow chart of the method of preparing an air purifying material according to one embodiment of the present disclosure, including:

Step 110. Mix zinc acetate and gallium nitrate to obtain a mixture, and add a solvent to the mixture to form a sol-gel precursor.

In one embodiment, the mixture may be obtained by mixing the zinc acetate having a purity over 99% and the gallium nitrate having a purity over 99%, and a sol-gel ZnGa₂O₄ precursor is obtained by adding a solvent to the mixture. The zinc acetate and the gallium nitrate are both in the form of powder.

Step 120. Sinter the sol-gel precursor to form a porous particulate zinc gallate precursor.

In one embodiment, the sol-gel ZnGa₂O₄ precursor may be sintered in a sintering container which may include a muffle furnace. The sol-gel ZnGa₂O₄ precursor is sintered with the organic substance volatilized during the sintering process to form a porous particulate zinc gallate precursor.

Step 130. Nitride the porous particulate zinc gallate precursor to form a porous solid solution of gallium nitride and zinc oxide.

In one embodiment, the porous particulate zinc gallate precursor may be located in a nitriding container, which may include a tube furnace. The ammonia gas is supplied to the nitriding container after the nitriding container is heated to a predetermined temperature so as to carry out the nitriding process and form the porous solid solution of GaN/ZnO.

Compared with the prior art, the present disclosure has the advantages set forth below.

In the embodiment of the present disclosure, the solvent is added to the mixture of the zinc acetate and the gallium nitrate to form a sol-gel precursor which is then sintered to form a porous particulate zinc gallate precursor. The porous particulate zinc gallate precursor forms a solid solution of gallium nitride and zinc oxide after undergoing a nitriding process. The porous solid solution of gallium nitride and zinc oxide is synthesized through the sol-gel method, which overcomes the problems of the low utilization efficiency of the solar energy, the small contact area with the organic pollutant and poor light degradation effect for the conventional photocatalyst. The porous solid solution of gallium nitride and zinc oxide can respond to the visible light, so that the utilization efficiency of the solar energy is improved. Additionally, the porous structure increases the contact area between the photocatalyst and the organic pollutant, such that the utilization of the photocatalyst is increased and light degradation effect to the organic pollutant is improved.

### Embodiment 2

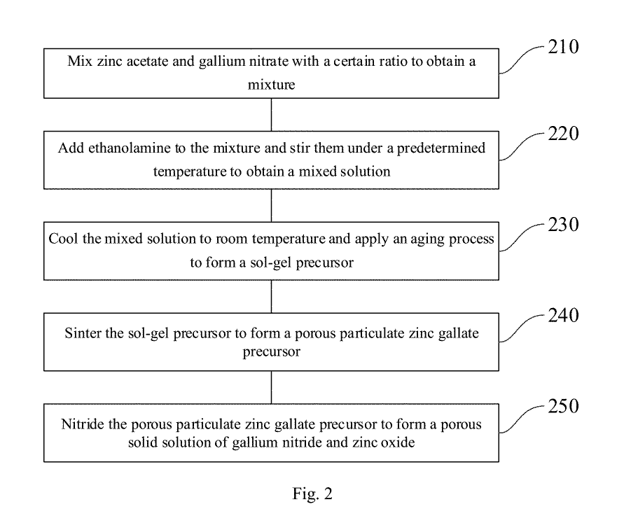

As shown in FIG. 2, it illustrates a flow chart of the method of preparing an air purifying material according to one embodiment of the present disclosure, including:

Step 210, mix zinc acetate and gallium nitrate with a certain ratio to obtain a mixture.

In one embodiment, the mixture may be obtained by mixing the zinc acetate having a purity over 99% and the gallium nitrate having a purity over 99% with a certain ratio and then pouring them into a beaker.

Step 220. Add ethanolamine to the mixture and stir them under a predetermined temperature to obtain a mixed solution.

In one embodiment, add analytically pure ethanolamine as a solvent into the mixture in the beaker and stir them under a predetermined temperature to obtain a mixed solution.

The analytically pure ethanolamine refers to the ethanolamine that has a high content of the essential component, high purity and low interference impurity, and is suitable for use in industrial analysis and chemical experiments.

Step 230. Cool the mixed solution to room temperature and subject it to an aging process to form a sol-gel precursor.

In one embodiment, the obtained mixed solution may be naturally cooled to room temperature. The mixed solution which has been cooled to room temperature may be placed in an aging container, which includes a refrigerator, to undergo an aging process and then form a sol-gel ZnGa₂O₄ precursor with the aid of the diffusion of molecules.

Step 240. Sinter the sol-gel precursor to form a porous particulate zinc gallate precursor.

In one embodiment, the sol-gel ZnGa₂O₄ precursor may be sintered in a sintering container which may include a muffle furnace. The sol-gel ZnGa₂O₄ precursor is sintered with the organic substance volatilized during the sintering process to form a porous particulate zinc gallate precursor.

Step 250. Nitride the porous particulate zinc gallate precursor to form a porous solid solution of gallium nitride and zinc oxide.

In one embodiment, the porous particulate zinc gallate precursor may be located in a nitriding container, which may include a tube furnace. The ammonia gas is supplied to the nitriding container after the nitriding container is heated to a predetermined temperature so as to nitride the porous particulate zinc gallate precursor and form the porous solid solution of GaN/ZnO.

Compared with the prior art, the present disclosure has the advantages set forth below.

In the embodiment of the present disclosure, the zinc acetate and the gallium nitrat are mixed with a certain ratio to obtain a mixture, and the ethanolamine is added the mixture to form a mixed solution after being sired under a predetermined temperature. The mixed solution is cooled to room temperature and then undergoes an aging process to form a sol-gel precursor, which is then sintered to form a porous particulate zinc gallate precursor. The porous particulate zinc gallate precursor forms a solid solution of gallium nitride and zinc oxide after undergoing a nitriding process. The porous solid solution of gallium nitride and zinc oxide is synthesized through the sol-gel method, which overcomes the problems of the low utilization efficiency of the solar energy, the small contact area with the organic pollutant and poor light degradation effect for the conventional photocatalyst. The porous solid solution of gallium nitride and zinc oxide can respond to the visible light, so that the utilization efficiency of the solar energy is improved. Additionally, the porous structure increases the contact area between the photocatalyst and the organic pollutant, such that the utilization of the photocatalyst is increased and light degradation effect to the organic pollutant is improved.

### Embodiment 3

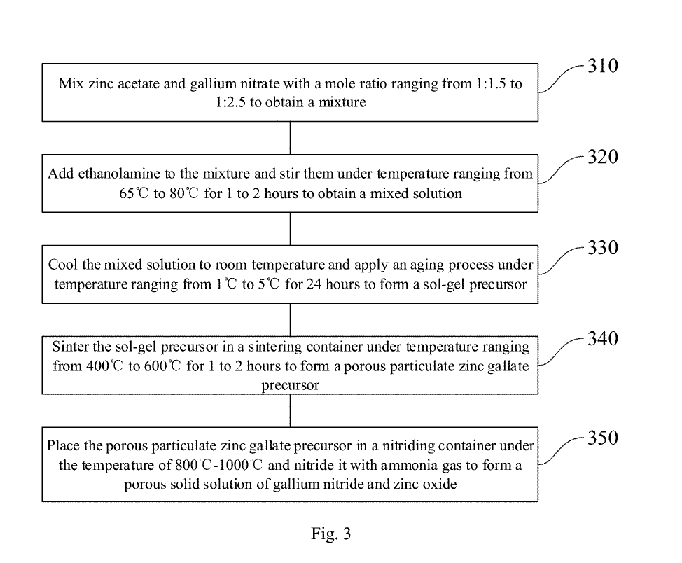

As shown in FIG. 3, it illustrates a flow chart of the method of preparing an air purifying material according to one embodiment of the present disclosure, including:

Step 310. Mix zinc acetate and gallium nitrate with a mole ratio ranging from 1:1.5 to 1:2.5 to obtain a mixture.

In one embodiment, the mixture may be obtained by mixing the zinc acetate having a purity over 99% and the gallium nitrate having a purity over 99% with a mole ratio ranging from 1:1.5 to 1:2.5, for example, 1:1.75, 1:2.15, or 1:2.25 and then pouring them into a beaker.

Step 320. Add ethanolamine to the mixture and stir them under temperature ranging from 65° C. to 80° C. for 1 to 2 hours to obtain a mixed solution.

In one embodiment, add analytically pure ethanolamine as a solvent into the mixture in the beaker and stir them under temperature ranging from 65° C. to 80° C. for 1 to 2 hours to obtain a mixed solution.

In order to form a sol-gel ZnGa₂O₄ precursor, the zinc acetate and the gallium nitrate need to be mixed at a certain ratio and produce ZnGa₂O₄ through chemical reaction. The atomic ratio of Zn to Ga in ZnGa₂O₄ is 1:2, so the mole ratio of zinc acetate to gallium nitrate is 1:2 in one embodiment.

In one embodiment, the step 320 includes:

Substep 321. Add ethanolamine to the mixture at a certain ratio and stir them by a magnetic stirrer in a water bath under temperature ranging from 65° C. to 80° C. for 1 to 2 hours to obtain a mixed solution.

1.8 g of zinc acetate having a purity over 99% and 5.2 g of gallium nitrate having a purity over 99% are mixed at a mole ratio of 1:2 and poured into the beaker to form a mixture. 1.5 mL-3 mL of analytically pure ethanolamine is added into the mixture in the beaker as a solvent. The beaker is placed in the water bath under temperature ranging from 65° C. to 80° C., preferably 70° C. A mixed solution is obtained through the magnetic stir by the magnetic rotor in the beaker for 1 to 2 hours.

When the zinc acetate is 1.8 g and the gallium nitrate is 5.2 g, they need ethanolamine of 1.5 mL-3 mL as a solvent. When the content of the zinc acetate and the gallium nitrate increase, the content of the ethanolamine increases in proportion accordingly.

For example, when the content of the zinc acetate and the gallium nitrate are 3.6 g and 10.4 g respectively, they need ethanolamine of 3 mL-6 mL as a solvent.

Step 330. Cool the mixed solution to room temperature and subject it to an aging process under temperature ranging from 1° C. to 5° C. for 24 hours to form a sol-gel precursor.

In one embodiment, the obtained mixed solution may be naturally cooled to room temperature. The mixed solution which has been cooled to room temperature may be placed in an aging container, which includes a refrigerator, under temperature ranging from 0° C. to 5° C., preferably 0° C., to undergo an aging process and then form a sol-gel ZnGa₂O₄ precursor with the aid of the diffusion of the molecules.

Step 340. Sinter the sol-gel precursor in a sintering container under temperature ranging from 400° C. to 600° C. for 1 to 2 hours to form a porous particulate zinc gallate precursor.

In one embodiment, the sol-gel ZnGa₂O₄ precursor is placed in a sintering container which includes a muffle furnace. The sintering container is heated to 400° C.-600° C., preferably 500° C., at a heating rate of 10° C./min. The sol-gel ZnGa₂O₄ is sintered in the sintering container under the temperature of 400° C.−600° C. for 1 to 2 hours. The organic substance in the sol-gel ZnGa₂O₄ precursor is completely volatilized during the sintering process, and a porous particulate zinc gallate precursor is obtained. The sintering container is naturally cooled to room temperature when the sintering process is finished, and then the porous particulate zinc gallate precursor is taken out.

Step 350. Place the porous particulate zinc gallate precursor in a nitriding container under the temperature of 800° C.-1000° C. and nitride it with ammonia gas to form a porous solid solution of gallium nitride and zinc oxide.

In one embodiment, the porous particulate zinc gallate precursor may be placed in a nitriding container, which includes a tube furnace. The nitriding container is heated to 800° C.-1000° C., preferably 900° C., at a heating rate of 5° C./min. The nitriding container of 800° C.-1000° C. is supplied with ammonia gas to nitride the porous particulate zinc gallate precursor so as to form a porous solid solution of gallium nitride and zinc oxide. The nitriding container is naturally cooled to room temperature when the nitriding process is finished, and then the porous solid solution of gallium nitride and zinc oxide is taken out.

In one embodiment, the flow of the ammonia gas ranges from 50-200 sccm (standard cubic centimeter per minute), and the nitriding process lasts 1 to 3 hours.

The porous particulate zinc gallate precursor may is placed in a nitriding container, which is heated to 800° C.-1000° C., preferably 900° C., at a heating rate of 5° C./min. The nitriding container of 800° C.-1000° C. is supplied with ammonia gas to nitride the porous particulate zinc gallate precursor for 1 to 3 hours so as to form a porous solid solution of gallium nitride and zinc oxide.

The temperature of the nitriding container is inversely proportional to the flow of the ammonia gas. That is, the higher the temperature of the nitriding container, the lower the flow of the ammonia gas; the lower the temperature of the nitriding container, the higher the flow of the ammonia gas. In one embodiment, the temperature of the nitriding container is 900° C., and the flow of the ammonia gas is 80 sccm.

Compared with the prior art, the present disclosure has the advantages set forth below.

In the embodiment of the present disclosure, the ethanolamine is added to the mixture of the zinc acetate and the gallium nitrate with a certain ratio to form a mixed solution after being sired under a predetermined temperature. The mixed solution is cooled to room temperature and then undergoes an aging process to form a sol-gel precursor, which is then sintered to form a porous particulate zinc gallate precursor. The porous particulate zinc gallate precursor forms a solid solution of gallium nitride and zinc oxide after undergoing a nitriding process. The porous solid solution of gallium nitride and zinc oxide is synthesized through the sol-gel method, which overcomes the problems of the low utilization efficiency of the solar energy, the small contact area with the organic pollutant and poor light degradation effect for the conventional photocatalysts. The porous solid solution of gallium nitride and zinc oxide can respond to the visible light, so that the utilization efficiency of the solar energy is improved. Additionally, the porous structure increases the contact area between the photocatalyst and the organic pollutant, such that the utilization of the photocatalyst is increased and light degradation effect to the organic pollutant is improved.

For the sake of simplicity, the method embodiments are described as a combination of a series of actions. However, those skilled in the art shall recognize that the embodiments of the present disclosure are not limited to the described sequence of the actions, since some steps can be carried out in another order or at the same time according to embodiments of the present disclosure. Secondly, it should be understood by those skilled in the art that the embodiments described in the specification are preferred embodiments and the actions involved are not necessarily required for the embodiments of the present disclosure.

### Embodiment 4

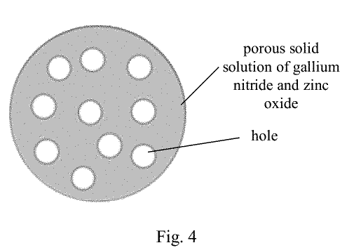

FIG. 4 schematically illustrates a structure of the air purifying material prepared according to the present disclosure.

The air purifying material includes a porous solid solution of gallium nitride and zinc oxide. The porous solid solution of gallium nitride and zinc oxide includes multiple holes, which have diameters ranging from 50 nm to 100 nm. The specific surface area of the porous solid solution of gallium nitride and zinc oxide ranges from 10 m²/g to 20 m²/g. The specific surface area refers to the total surface area of a material per unit of mass.

The air purifying material is prepared by the above method of preparing an air purifying material, which includes: preparing a porous particulate zinc gallate precursor; and nitriding the porous particulate zinc gallate precursor to form the porous solid solution of gallium nitride and zinc oxide. The formed porous solid solution of gallium nitride and zinc oxide can utilize the visible light and increase the contact area with the organic pollutants such that the organic pollutants can be effectively degraded. For example, the degradation efficiency of the porous solid solution of gallium nitride and zinc oxide may have a high efficiency up to 600 ppm/h in degrading the organic pollutants of isopropyl alcohol.

The porous solid solution of gallium nitride and zinc oxide (GaN/ZnO) has a unique energy band structure. The bottom of the conduction band of the GaN/ZnO solid solution mainly consists of the 4s and 4p orbits of Ga, and the top of the valence band consists of Zn3d and N2p orbits. Since Zn3d and N2p have p-d orbital exclusion effect, the position of the valence band raises with the band position almost constant, resulting in reduced band gap. Hence, the visible light can be utilized. The band gap can be adjusted controllably by adjusting the ratio of N to Zn, such that the solar spectrum which can be utilized may be extended to 420-550 nm.

The resulted porous solid solution of gallium nitride and zinc oxide may absorb the visible light in the wavelength range of 420-550 nm. Through the activating of the visible light, the electrons jump from the valence band to the conduction band with photogenerated electrons produced in the conduction band and photogenerated holes produced in the valence band. On the surface of the porous solid solution of gallium nitride and zinc oxide, the photogenerated electrons and holes react with the oxygen and water vapor in the air to produce different free radical trapping agents comprising ⁻OH, H⁺, and O₂⁻, by which the organic pollutants in the air are degraded to water and carbon dioxide.

Compared with the prior art, the present disclosure has the advantages set forth below.

In the embodiment of the present disclosure, the porous solid solution of gallium nitride and zinc oxide is synthesized through the sol-gel method, which overcomes the problems of the low utilization efficiency of the solar energy, the small contact area with the organic pollutant and poor light degradation effect for the conventional photocatalyst. The porous solid solution of gallium nitride and zinc oxide can respond to the visible light, so that the utilization efficiency of the solar energy is improved. Additionally, the porous structure increases the contact area between the photocatalyst and the organic pollutant, such that the utilization of the photocatalyst is increased and light degradation effect to the organic pollutant is improved.

For the embodiments of the air purifying material, reference is made to the description of the embodiments of the method of preparing the air purifying material.

Numerous specific details are set forth in the specification provided herein. However, it will be understood that the embodiments of the present disclosure may be implemented without these specific details. In some embodiments, in order to avoid influencing the understanding of the present specification, the customary methods, structures and technical means are not described in detail.

Similarly, it should to be understood that, in order to simplify the present disclosure and assist in understanding one or more of the various aspects of the present disclosure, in the above description of the exemplary embodiments, the features of the present disclosure are sometimes grouped together into a single embodiment, drawing, or description thereof. However, the disclosed method should not be considered as reflecting the following intention: the present disclosure claims more features than the features clearly recorded in each claim. More specifically, as reflected in the following claims, one aspect of the present disclosure has less features than the features previously disclosed in single embodiment. Accordingly, the claims that are in line with the embodiments are explicitly incorporated into this specific embodiment, wherein each claim itself may be taken as an embodiment of the disclosure.

It will be understood by those skilled in the art that, persons skilled in the art may, on the basis of the above embodiments, combine the specific content point values of a certain component of these embodiments with the technical solutions described in the section of SUMMARY, so as to obtain new numerical ranges, which also falls into the protection scope of the present disclosure. For simplifying the specification, these new numerical ranges are not listed herein.

The manufacturing process of the present disclosure is illustrated by the above-described embodiments, but the present disclosure is not limited to the above-described manufacturing steps. That is to say, the present disclosure does not have to be carried out through the above-described manufacturing steps. It will be apparent to those skilled in the art that any improvements to the present disclosure, equivalent substitution of the selected materials, addition of auxiliary ingredients, selection of specific ways, etc., fall within the scope of the present disclosure and the scope of the disclosure.

The preferable embodiments are described in detail above. However, the present disclosure is not limited to the specific details in the above embodiments. Various simple modifications of the technical solution of the present disclosure can be made within the technical concept of the present disclosure, and these simple variants are within the protection scope of the present disclosure. It is noted that the specific technical features described in the above embodiments can be combined in any suitable manner if there is no contradiction. In order to avoid unnecessary repetition, the present disclosure will not further describe the various possible combination. In addition, any combination of the multiple different embodiments of the disclosure may be possible as long as it does not contravene the idea of the disclosure and should be considered as the disclosure of the present disclosure.

Moreover, it will be understood by those skilled in the art that although some of the embodiments described herein include certain features rather than other features, combinations of the features of different embodiments are intended to be within the scope of the disclosure and to form different embodiments.

For example, in the following claims, any one of the claimed embodiments may be used in any combination.

It is noted that the above embodiments are used to illustrate the disclosure but are not to limit the present disclosure. The person skilled in the art may design alternative embodiments without departing from the scope of the appended claims. In the claims, any reference signs between parentheses should not be considered as limiting the claims. The word “comprising” does not exclude the presence of elements or steps not listed in the claims. The word “one” or “a” before the element does not exclude the presence of a plurality of such elements. The present disclosure may be implemented by means of hardware comprising multiple different elements or a suitably programmed computer. In the unit claims listing a plurality of devices, several ones of these devices may be embodied by the same hardware. The words first, second, and third do not refer to any sequence. These words may be considered as names.

What is claimed is:

1. A method of preparing an air purifying material, wherein the air purifying material comprises a porous solid solution of gallium nitride and zinc oxide, and the method comprises:
mixing zinc acetate and gallium nitrate to obtain a mixture, and adding a solvent to the mixture to form a sol-gel precursor;
sintering the sol-gel precursor to form a porous particulate zinc gallate precursor; and
nitriding the porous particulate zinc gallate precursor to form the porous solid solution of gallium nitride and zinc oxide.

2. The method of claim 1, wherein the step of mixing zinc acetate and gallium nitrate to obtain a mixture and adding a solvent to the mixture to form a sol-gel precursor comprises:
mixing zinc acetate and gallium nitrate with a certain ratio to obtain a mixture;
adding ethanolamine to the mixture and stirring under a predetermined temperature to obtain a mixed solution; and
cooling the mixed solution to room temperature and applying an aging process to form a sol-gel precursor.

3. The method of claim 2, wherein in the step of mixing zinc acetate and gallium nitrate with a certain ratio to obtain a mixture, a mole ratio of zinc acetate to gallium nitrate ranges from 1:1.5 to 1:2.5.

4. The method of claim 3, wherein the mole ratio of zinc acetate to gallium nitrate is 1:2.

5. The method of claim 2, wherein in the step of adding ethanolamine to the mixture and stirring under a predetermined temperature to obtain a mixed solution, the predetermined temperature ranges from 65° C. to 80° C., and the stirring lasts 1 to 2 hours.

6. The method of claim 5, wherein the step of adding ethanolamine to the mixture and stirring under a predetermined temperature to obtain a mixed solution comprises:
adding ethanolamine to the mixture at a certain ratio and stir them by a magnetic stirrer in a water bath under temperature ranging from 65° C. to 80° C. for 1 to 2 hours to obtain a mixed solution.

7. The method of claim 2, wherein in the step of applying an aging process to form a sol-gel precursor, the aging process temperature ranges from 0° C. to 5° C., and the aging process lasts 24 hours.

8. The method of claim 1, wherein the step of sintering the sol-gel precursor to form a porous particulate zinc gallate precursor comprises:
sintering the sol-gel precursor in a sintering container under temperature ranging from 400° C. to 600° C. for 1 to 2 hours to form a porous particulate zinc gallate precursor.

9. The method of claim 1, wherein the step of nitriding the porous particulate zinc gallate precursor to form a porous solid solution of gallium nitride and zinc oxide comprises:
placing the porous particulate zinc gallate precursor in a nitriding container under the temperature of 800° C.-1000° C. and nitriding it with ammonia gas to form a porous solid solution of gallium nitride and zinc oxide.

10. The method of claim 9, wherein in the step of nitriding with ammonia gas, the flow of the ammonia gas ranges from 50-200 sccm, and the nitriding process lasts 1 to 3 hours.

11. An air purifying material, wherein the air purifying material comprises a solid solution of gallium nitride and zinc oxide and is prepared through the method of preparing an air purifying material according to claim 1.

12. The air purifying material of claim 11, wherein the diameters of the holes in the porous solid solution of gallium nitride and zinc oxide range from 50 nm to 100 nm.

13. The air purifying material of claim 11, wherein the specific surface area of the porous solid solution of gallium nitride and zinc oxide ranges from 10 m²/g to 20 m²/g.
